(19) United States
(12) Patent Application Publication
(10) Pub. No.: US 2022/0050532 A1
(43) Pub. Date: Feb. 17, 2022

(54) KEYBOARD WITH AN INDEPENDENT BRACKET

(71) Applicant: Shenzhen Hastech Industries Co., Ltd, Shenzhen (CN)

(72) Inventor: Jinlu Zhang, Shenzhen (CN)

(21) Appl. No.: 17/032,353

(22) Filed: Sep. 25, 2020

(30) Foreign Application Priority Data
Aug. 17, 2020 (CN) 202021729216.9

(51) Int. Cl. G06F 3/02; A47B 23/06; A47B 23/04

(52) U.S. Cl. CPC G06F 3/0208; A47B 2023/049; A47B 23/043; A47B 23/06

(57) ABSTRACT

The present invention provides a keyboard with an independent bracket, which is able to adjust the included angle of the second panel relative to the first panel by an adjustment unit, so that the supported display device has different visual angles. Unlike the protective case for a specific type of the display device, the present invention is able to adjust the supporting angle and the supporting position of the display device, so that the display devices of different sizes are able to be supported.

### CROSS REFERENCE TO RELATED APPLICATIONS

The present application claims the benefit of Chinese Patent Application No. 202021729216.9 filed on Aug. 17, 2020, the contents of which are incorporated herein by reference in their entirety.

### TECHNICAL FIELD

The present invention relates to the field of manufacturing protective cases for mobile devices, and more particularly, to a keyboard with an independent bracket.

### BACKGROUND

Nowadays, with the development of the Internet, the external application scenario of the keyboard is no longer limited to the conventional mode. In some cases, people need to carry the keyboard to connect with mobile devices such as a tablet, a computer, and a mobile phone for multiple purposes such as work and entertainment. However, most existing keyboards are bulky. When the keyboard is connected to the mobile devices such as the tablet, the computer, and the mobile phone in a wired or wireless manner, the keyboard is not able to support the mobile devices. Therefore, an additional bracket is required to support the mobile devices and adjust the visual angle of the screen.

U.S. Pat. No. US20120211377A1 discloses a combination of a protective case and a bracket for a display device and a keyboard, so that a user is able to carry the portable keyboard and support the display device by the bracket, thereby meeting the trouble caused by the separation of the keyboard and the bracket, but still not solving the problem that the bracket support angle is not adjustable, and is only able to support a display device of a fixed size.

### DESCRIPTION OF THE INVENTION

In order to solve the above-mentioned technical problem, the present invention discloses a keyboard with an independent bracket. The technical solution of the present invention is implemented as follows:

A keyboard with an independent bracket comprises a bracket and a first keyboard; the bracket comprises: a first panel movably connected to the first keyboard so that the two are relatively unfolded or folded; A second panel pivotally connected to the first panel; the second panel configured with a support portion for supporting a display device; an adjustment unit configured between the second panel and the first panel for adjusting the included angle between the second panel and the first panel to change the position of the support portion, so as to adjust the tilt angle of the screen of the display device; the keyboard comprises: the second panel rotated about a pivot such that the second panel and the adjustment unit are received in the first panel.

Preferably, one end of the adjustment unit is configured with a rotating portion, and the other end of the adjustment unit is configured with a slider mechanism; the slider mechanism is slidable in a chute configured in the first panel to change the included angle, and the rotating portion is pivotally connected to the second panel.

Preferably, the chute is configured between the position in which the first panel is movably connected to the first keyboard and the position in which the second panel is pivotally connected to the first panel.

Preferably, the chute is configured with a limiting bayonet; the limiting bayonet is able to restrict the movement of the slider mechanism; the slider mechanism comprises a resilient portion capable of disengaging from the limiting bayonet when a certain external force is applied to the adjustment unit.

Preferably, the first panel is configured with a concave structure, and the second panel and the adjustment unit is able to be embedded in the concave structure such that the bracket has a receiving state that the outer side surface of the second panel does not protrude the concave structure.

Preferably, the second panel is a U-shaped structure, and the support portion is configured at the bottom of the U-shaped structure, and both sides of the opening of the U-shaped structure are connected to the first panel by a hinge structure.

Preferably, one or more of the first panel, the second panel, and the adjustment unit are configured with a groove structure which facilitates a user to buckle so that the keyboard changes from a receiving state to an unfolded state.

Preferably, a first magnetic portion is configured on the first panel, and a second magnetic portion is configured on the second panel at the position corresponding to the first magnetic portion, wherein the first magnetic portion and the second magnetic portion are able to generate a magnetic attraction force with each other when getting close.

Preferably, at least one second keyboard structure is further included, wherein the second keyboard structure is movably connected to the first keyboard.

Preferably, the first panel and/or the first keyboard are configured with fixed grooves and/or fixed bars for restricting the sliding of the display device relative to the first panel.

The implementation of the technical solution of the invention is able to solve the technical problems in the prior art that the portable keyboard is not able to support the display device of various sizes and the supporting angle provided by the bracket is not able to be adjusted; according to the technical solution of the present invention, a keyboard with an independent bracket comprises a bracket and a first keyboard, wherein the bracket comprises below parts: a first panel movably connected to the first keyboard; a second panel pivotally connected to the first panel; the second panel for supporting a display device; an adjustment unit capable of adjusting the included angle of the second panel relative to the first panel; the first panel, the second panel, and the adjustment unit enable the bracket at least has: an unfolded state in which the side edges and the back surfaces of the display device are supported. The included angle of the second panel relative to the first panel is able to be adjusted by the adjustment unit so that the supported display device has different visual angles. Unlike the protective case for a specific type of the display device, the present invention is able to adjust the supporting angle and the supporting position of the display device, so that the display devices of different sizes are able to be supported.

### DESCRIPTION OF THE DRAWINGS

In order to describe the embodiments of the present invention or the technical solutions in the prior art more clearly, reference below will be made briefly to the accompanying drawings required for the description of the embodiments or the prior art. It is apparent that the accompanying drawings in the following description are merely one embodiment of the present invention, and other drawings may be made to those skilled in the art without involving any inventive effort.

FIG. 1 is a schematic structural diagram of an unfolded state according to an embodiment of the present invention;

FIG. 2 is a schematic structural diagram of a supported display device in an unfolded state according to an embodiment of the present invention;

FIG. 3 is a schematic structural diagram of a receiving state according to an embodiment of the present invention;

FIG. 4 is a schematic structural diagram of a slider mechanism according to an embodiment of the present invention;

FIG. 5 is a schematic structural diagram of an embodiment of the present invention with a second keyboard structure;

FIG. 6 is a schematic diagram of a folded state according to an embodiment of the present invention.

### DETAILED DESCRIPTION OF EMBODIMENTS

The technical solution in the embodiments of the present invention will be clearly and completely described with reference to the accompanying drawings of the embodiments of the present invention, and it is apparent that the described embodiments are merely part of, but not all of, the embodiments of the present invention. Based on the embodiments of the present invention, all other embodiments obtained by those skilled in the art without involving any inventive effort are within the protection scope of the present invention.

In the present invention, unless otherwise expressly stated and defined, the terms “configured”, “connected”, “engaged”, “fixed” and others should be understood in a broad sense, for examples, it may be fixed connected, detachable connected, or integrated connected; It may be mechanical connected or electrical connected; It may be directly connected, or indirectly connected by an intermediate medium, or internal communication of two elements. The specific definition of the above terms in the present invention is able to be understood by those skilled in the art according to specific circumstances.

In the present invention, unless otherwise expressly stated and defined, a first feature “above” or “below” a second feature may include direct contact of the first and second features, as well as indirect contact of the first and second features by additional features therebetween. Moreover, the first feature “above”, “on” and “over” the second feature include that the first feature is right above and obliquely above the second feature, or merely indicate that the level of the first feature is higher than that of the second feature. The first feature “below”, “under” and “beneath” the second feature include that the first feature right below and obliquely below the second feature, or merely indicate that the level of the first feature level is lower than that of the second feature.

The present invention will be described in further detail by specific embodiments with reference to the accompanying drawings as follows.

A keyboard with an independent bracket comprises a bracket and a first keyboard, the bracket comprises below: a first panel movably connected to the first keyboard so that the two are relatively unfolded or folded; a second panel pivotally connected to the first panel; the second panel configured with a support portion for supporting a display device; an adjustment unit configured between the second panel and the first panel for adjusting the included angle between the second panel and the first panel to change the position of the support portion, so as to adjust the tilt angle of the screen of the display device; the keyboard comprises: the second panel rotated about a pivot such that the second panel and the adjustment unit are received in the first panel.

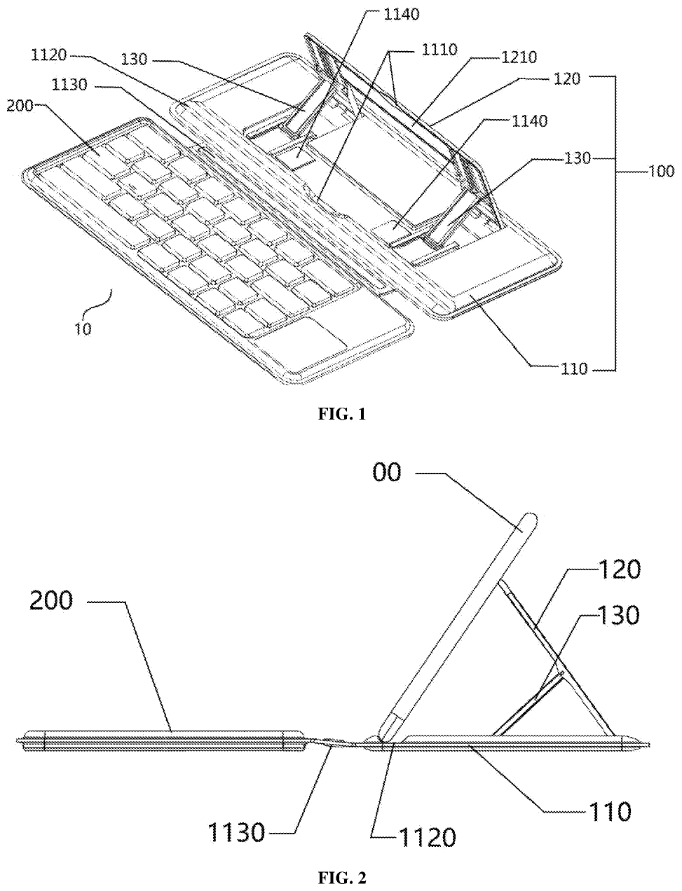

Specifically, as shown in FIG. 1, a keyboard 10 with an independent bracket comprises a bracket 100 and a first keyboard 200; the bracket 100 comprises a first panel 110, a second panel 120, and an adjustment unit 130; the first panel 110 movably connected to the first keyboard 200; the second panel 120 pivotally connected to the first panel 110; the second panel 120 for supporting a display device; the adjustment unit 130 capable of adjusting the included angle of the second panel 120 relative to the first panel 110. The movable connection may be connected by a flexible material. The folded state and the unfolded state of the first panel and the first keyboard are able to be switched by the characteristics of the flexible material so as to be portable; the movable connection may also be achieved by a rigid structure that is pivotally connected. The second panel 120 is pivotally connected to the first panel so that the second panel is able to be pivotally rotated at the position pivotally connected to the first panel, and the included angle between the first panel and the second panel is adjusted and fixed by the adjustment unit so as to form a bracket. As shown in FIG. 2, the first panel 110, the second panel 120 and the adjustment unit 130 enable the bracket 100 at least has: an unfolded state in which the side edges and the back surfaces of the display device are supported, and the display device 00 is able to be supported in the unfolded state. By the adjustable bracket composed of the first panel, the second panel and the adjustment unit, the adjustment unit is able to adjust the included angle of the second panel relative to the first panel, so that the supported display device has different visual angles. Unlike the protective case for a specific type of the display device, the present invention is able to adjust the supporting angle and the supporting position of the display device, so that the display devices of different sizes are able to be supported. The keyboard structure may be any technical solution in the prior art such as a Bluetooth keyboard, a Wifi keyboard, or a wired keyboard. The technical solutions formed in combination with the technical solution disclosed in the present invention are within the protection scope of the present invention.

In a preferred embodiment, one end of the adjustment unit is configured with a rotating portion, and the other end of the adjustment unit is configured with a slider mechanism capable of sliding in a chute configured in the first panel to change the included angle, wherein the rotating portion is pivotally connected to the second panel. As shown in FIG. 1 to FIG. 4 of the accompanying drawings, one end of the adjustment unit 130 is a rotating portion 1310, and the other end of the adjustment unit 130 is a slider mechanism 1320 which is able to slide in a chute 1330; the chute 1330 is configured on the first panel 110, and the rotating portion 1310 is pivotally connected to the second panel 120, or the chute 1330 is configured on the second panel 120, and the rotating portion 1310 is pivotally connected to the first panel 110. In the present embodiment, the process of the deformation to be a bracket does not require disassembly and positioning of the first panel, the second panel and the adjustment unit, respectively, and does not result in a discrete unfolded structural state, which is relatively compact in structure. When a user supports a mobile device by the bracket, the user disconnects the first panel and the second panel from the non-pivotally connected side, and the adjustment unit slides within a fixed range while supporting the first panel and the second panel; when folding the bracket, the first panel and the second panel are closed on one side of the non-pivotal connection, and the adjustment unit slides within a fixed range until the first panel and the second panel are adhered to each other, thereby completing folding and receiving of the bracket. Throughout use, the user does not need to directly adjust the adjustment unit in which the structure position is located near inner, and the adjustment of the bracket is able to be realized only by adjusting the first panel and the second panel, thus the user has a good experience of use.

In a preferred embodiment, the chute is configured between the position in which the first panel is movably connected to the first keyboard, and the position in which the second panel is pivotally connected to the first panel. As shown in FIG. 2, when the included angle between the first panel and the second panel is less than 90° and the display device 00 is supported, the force received by the second panel is able to be carried by the structure in which the second panel is pivotally connected to the first panel, thereby reducing the force directly received by the adjustment unit. Additional force causes the adjustment unit to displace when one end of the adjustment unit is a slider mechanism, thereby damaging the angle at which the bracket is supported. When the user opens the folded bracket and the first keyboard in the reverse direction of gravity, the slider mechanism does not automatically slide out due to the gravity action of the second panel, so that the bracket is not accidentally opened when only the keyboard function needs to be opened and the bracket does not need to be opened.

In a preferred embodiment, the chute is configured with a limiting bayonet, and the limiting bayonet is able to restrict the movement of the slider mechanism. The slider mechanism comprises a resilient portion capable of disengaging the restriction of the limiting bayonet when a certain external force is applied to the adjustment unit. As shown in FIG. 4, the chute 1330 is configured with a limiting bayonet 13310, and the limiting bayonet 13310 is able to be elastically fixed as one end of the adjustment unit of the slider mechanism 1320. When a certain external force is applied to the adjustment unit 130, the adjustment unit 130 as one end of the slider mechanism 1320 is able to disengage the limiting bayonet 13310 which is elastically fixed. The limiting bayonet 13310 may be implemented in a variety of ways, such as a resilient sheet metal and a buckle. Any technical solution in the prior art may be used to combine the technical solution disclosed in the present invention, and the technical solutions formed are within the protection scope of the present invention. The limiting bayonet 13310 is able to be fixed to the sliding of the adjustment unit, thereby locking the elevation angle of the bracket, and further fixing the visual angle of the mobile device supported on the bracket. Within a certain force range, the visual angle of the mobile device supported does not change due to the relative structure of the three components in the bracket. The single limiting bayonet may have a fixing effect, and preferably, the number of limiting bayonets on the chute may be set to at least two. As shown in FIG. 4, there are at least two limiting bayonets 13310 on the chute 1330. The slider mechanism 1320 is able to be fixed at both ends of the slider mechanism 1320 by configuring the limit bayonets 13310 at the same position on both sides of the slider mechanism 1320 on the chute 1330, thereby increasing the stability of the fixing effect of the limit bayonets 13310. Configuring a plurality of limit bayonets 13310 at different positions of the slider mechanism 1320 on the chute 1330 enables the adjustment unit to have a plurality of fixed angles, thereby the overall bracket has a plurality of fixed elevation angles, and providing a plurality of fixed visual angles for the mobile device supported on the bracket.

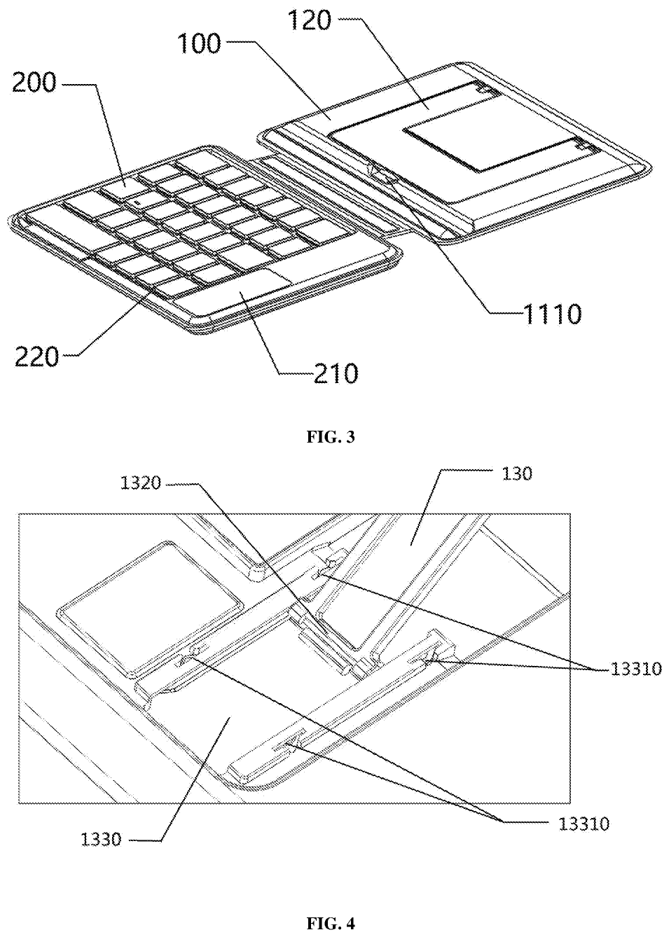

In a preferred embodiment, the first panel is configured with a concave structure, wherein the second panel and the adjustment unit are able to be embedded in the concave structure such that the bracket at least has: the surface of the first panel on one side of the concave structure that does not include a convex receiving state. As shown in FIG. 3 and FIG. 5, the bracket presents a plane in a receiving state, and no protrusion is generated in the receiving state, so that it is able to better place a laptop or other articles when the bracket does not need to be unfolded. Meantime, no protrusion is generated to press the keys or surfaces on the keyboard structure.

In a preferred embodiment, the second panel is a U-shaped structure, wherein the support portion is configured at the bottom of the U-shaped structure, and both sides of the opening of the U-shaped structure are connected to the first panel by a hinge structure. As shown in FIG. 1, FIG. 3, and FIG. 5, the second panel may be configured in a U-shaped structure. Technically, the U-shaped structure reduces the consumable area of the second panel without affecting the area of the support portion, thereby adjusting the production cost; when the density of the material used in the second panel is high, the overall weight is able to be reduced. The two hinges configured independently are able to have an easy-to-install feature, and the size of the machined parts is also smaller, thereby reducing the impact on structural stability due to production errors.

In a preferred embodiment, any one or more of the first panel, the second panel, and the adjustment unit are configured with a groove structure which facilitates a user to buckle so that the keyboard changes from a receiving state to an unfolded state. As shown in FIG. 1 and FIG. 4, the first panel 110 and/or the second panel 120 and/or the adjustment unit 130 are configured with a groove structure 1110, which facilitates a user to buckle. The groove structure 1110 enables the user's fingers to conveniently unfold the first panel and the adjustment unit so that a user with a larger hand shape obtains better opening efficiency when the overall structure is made smaller.

In a preferred embodiment, a first magnetic portion is configured on the first panel, and a second magnetic portion is configured on the second panel at the position corresponding to the first magnetic portion, wherein the first magnetic portion and the second magnetic portion are able to generate a magnetic attraction force with each other when getting close. As shown in FIG. 1, a first magnetic portion 1140 is configured on the first panel 110, and a second magnetic portion 1210 is configured on the second panel 120 at the position corresponding to the first magnetic portion 1140, wherein the first magnetic portion 1140 and the second magnetic portion 1210 are able to generate a magnetic attraction force with each other when getting close. The interaction of the first magnetic portion 1140 and the second magnetic portion 1210 makes it impossible for the bracket to automatically unfold due to gravity or a slight external force when the bracket is in the receiving state, thereby increasing the stability of the device.

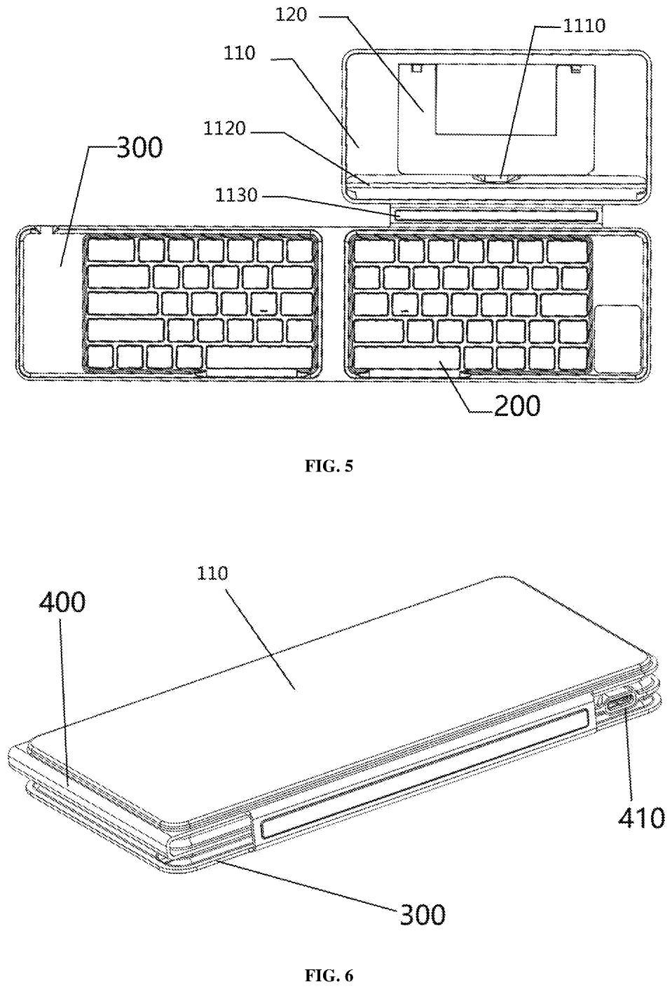

In a preferred embodiment, at least one second keyboard structure is further included, and the second keyboard structure is movably connected to the first keyboard. As shown in FIG. 5 and FIG. 6, at least one second keyboard structure 300 is further included, and the second keyboard structure 300 is movably connected to the first keyboard 200. With the introduction of the second keyboard structure 300, the keys originally arranged on the first keyboard 200 are able to be more flexibly assigned to the first keyboard 200 or the second keyboard structure 300, so that larger keys are able to be configured on the keyboards without changing the area of a single keyboard structure, thereby improving the user experience. As shown in FIG. 5, the added second keyboard structure may also be folded with the first keyboard and the volume of the folded keyboards is not significantly increased. The added second keyboard structure 300 may be movably connected to any position of the first keyboard 200, and the second keyboard structure 300 may also be a keyboard structure group composed of a plurality of keyboard structures, which may be configured for charging and wired data transmission by a communication interface 410. The first keyboard and/or the second keyboard may be configured with a concave region, and the edges of the concave region are convex so that the keys are not squeezed when the keyboard is integrally folded, and the keys are able to be protected by being set in the concave region. As shown in FIG. 1, the first keyboard and/or the second keyboard may be configured with an additional module 210, and it may be used to configure a fingerprint recognition module, a touch screen, a switch, a solar charging panel or other functional modules, which will not be described further herein as belonging to the prior art.

In a preferred embodiment, the first panel and/or the first keyboard are configured with fixed grooves and/or fixed bars for restricting the sliding of the display device relative to the first panel. As shown in FIG. 1, FIG. 2 and FIG. 5, the first panel 110 and/or the first keyboard 200 are configured with a fixed groove 1120 and/or a fixed bar 1130. The fixed groove 1120 and the fixed bar 1130 are able to limit the bottom of the supported mobile device, thereby making the supported mobile device more stable.

In the description of the present specification, reference to the term “one embodiment,” “some embodiments,” “an embodiment,” “a plurality of embodiments,” “examples,” “specific examples,” or “some examples,” and the like, means that specific features, structures, materials, or characteristics described in connection with the embodiments or examples is included in at least one embodiment or example of the present invention. In the present specification, the schematic representations of the above terms do not necessarily refer to the same embodiments or examples. Moreover, the specific features, structures, materials, or characteristics described may be combined in any one or more embodiments or examples in a suitable manner.

The foregoing is the further detailed description of the present invention in connection with the specific embodiments, and it is not able to be considered that the specific embodiments of the present invention are limited to these descriptions. For those skilled in the art to which the present invention belongs, a number of simple deductions or substitutions may be made without departing from the concept of the present invention.

It should be noted that the foregoing is merely preferred embodiments of the present invention, and is not intended to limit the present invention. Any modification, equivalent replacement, improvement and the like made within the spirit and principles of the present invention shall be included within the protection scope of the present invention.

What is claimed is:

1. A keyboard with an independent bracket, comprises a bracket and a first keyboard, wherein the bracket comprises:
A first panel movably connected to the first keyboard so that the two are able to be relatively unfolded or folded;
A second panel pivotally connected to the first panel; the second panel configured with a support portion for supporting a display device;
An adjustment unit configured between the second panel and the first panel for adjusting the included angle between the second panel and the first panel to change the position of the support portion so as to adjust the tilt angle of the screen of the display device;
The keyboard comprises: the second panel rotated about a pivot such that the second panel and the adjustment unit are received in the first panel.

2. The keyboard with an independent bracket according to claim 1, wherein one end of the adjustment unit is configured with a rotating portion, and the other end of the adjustment unit is configured with a slider mechanism capable of sliding in a chute configured in the first panel to change the included angle, and the rotating portion is pivotally connected to the second panel.

3. The keyboard with an independent bracket according to claim 2, wherein the chute is configured between the position in which the first panel is movably connected to the first keyboard and the position in which the second panel is pivotally connected to the first panel.

4. The keyboard with an independent bracket according to claim 2, wherein the chute is configured with a limiting bayonet, and the limiting bayonet is able to restrict the movement of the slider mechanism, and the slider mechanism comprises a resilient portion that is able to be disengaged from the restriction of the limiting bayonet when an external force is applied to the adjustment unit.

5. The keyboard with an independent bracket according to claim 1, wherein the first panel is configured with a concave structure, and the second panel and the adjustment unit is able to be embedded in the concave structure such that the bracket has: a receiving state that the outer side surface of the second panel does not protrude the concave structure.

6. The keyboard with an independent bracket according to claim 5, wherein the second panel is a U-shaped structure, and the support portion is configured at the bottom of the U-shaped structure, and both sides of the opening of the U-shaped structure are connected to the first panel by a hinge structure.

7. The keyboard with an independent bracket according to claim 6, wherein any one or more of the first panel, the second panel and the adjustment unit are configured with a groove structure that facilitates a user to buckle so that the keyboard changes from a receiving state to an unfolded state.

8. The keyboard with an independent bracket according to claim 1, wherein a first magnetic portion is configured on the first panel, and a second magnetic portion is configured on the second panel at the position corresponding to the first magnetic portion, and the first magnetic portion and the second magnetic portion are able to generate a magnetic attraction force when getting close.

9. The keyboard with an independent bracket according to claim 1, wherein at least one second keyboard structure is further included, and the second keyboard structure is movably connected to the first keyboard.

10. The keyboard with an independent bracket according to claim 1, wherein the first panel and/or the first keyboard are configured with fixed grooves and/or fixed bars for restricting the sliding of the display device relative to the first panel.
